(19) United States
(12) Patent Application Publication
(10) Pub. No.: US 2017/0064760 A1
(43) Pub. Date: Mar. 2, 2017

(54) ASSISTED WIRELESS CONNECTION SETUP

(71) Applicant: QUALCOMM Incorporated, San Diego, CA (US)

(72) Inventors: Manohar Kandagadla, Hyderabad (IN); Suresh Kumar Bitra, Hyderabad (IN); Venkatarao Reddy Buddala, Hyderabad (IN); Naresh Kumar Gupta Varada, Hyderabad (IN)

(21) Appl. No.: 14/838,753

(22) Filed: Aug. 28, 2015

(51) Int. Cl. H04W 76/02; H04W 36/36; H04W 12/02; H04L 29/06; H04W 4/00; H04W 48/16

(52) U.S. Cl. CPC H04W 76/025; H04W 4/008; H04W 48/16; H04W 12/02; H04L 63/0428; H04W 36/36; H04W 84/12

(57) ABSTRACT

A method and apparatus for connecting a wireless station (STA) to an access point (AP). The STA initiates a wireless connection exchange with the AP and offloads at least a portion of the wireless connection exchange to a peripheral device. The STA receives a message from the peripheral device, and enables secure data communications with the AP based at least in part on the message received from the peripheral device.

### TECHNICAL FIELD

The example embodiments relate generally to wireless networks, and specifically to offloading, to a peripheral device, at least a portion of the process of setting up a wireless connection between a wireless station and an access point.

### BACKGROUND OF RELATED ART

A wireless local area network (WLAN) may be formed by one or more access points (APs) that provide a shared wireless communication medium for use by a number of client devices or stations (STAs). Establishing a wireless connection between an AP and a STA typically involves a number of steps that must be completed (in order) before the STA and AP can begin exchanging data with one another. First, the STA typically scans all available wireless channels (e.g., by broadcasting probe requests and/or listening for beacon frames) to identify APs and/or other devices that are within wireless communication range. Each available AP may respond to a probe request by sending back a probe response containing basic service set (BSS) pertaining to that AP's network (e.g., WLAN). Next, the STA selects one of the APs to connect to, for example, based on the associated network information (e.g., the STA may select the AP with the highest signal strength). The STA then authenticates and associates with the selected AP. Finally, the STA performs a 4-way handshake with the AP to generate dynamic keys for encrypting (and decrypting) data communicated between the devices.

The process of scanning available wireless channels and/or establishing a connection with an AP is time-consuming. For example, the 4-way handshake operation is typically performed at a much lower data rate than other data or communication exchanges in a WLAN. This may prevent the STA from communicating with other devices while the handshake operation is ongoing and/or cause the handshake operation to be susceptible to interruption by other processes executing on the STA.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method and apparatus for connecting a wireless station (STA) to an access point (AP) are disclosed. The STA initiates a wireless connection exchange with the AP and offloads at least a portion of the wireless connection exchange to a peripheral device. For example, the STA may be “tethered” to (e.g., in constant or continuous communication with) the peripheral device via a Bluetooth link or a near field communication (NFC) link. In some examples, the offloading may be triggered by the STA switching to a different wireless communication protocol (e.g., from a Wi-Fi communication protocol to a Bluetooth communication protocol). The STA further receives a message from the peripheral device, and enables secure data communications with the AP based at least in part on the message received from the peripheral device.

The portion of the wireless connection exchange performed by the peripheral device may include an Extensible Authentication over Local Area Network (EAPoL) handshake operation. For example, the peripheral device may exchange EAPoL frames with the AP to generate a set of encryption keys. The peripheral device may further provide the set of encryption keys to the STA via the wireless communication. The STA may use the set of encryption keys received from the peripheral device to encrypt or decrypt the data communications with the AP.

In some examples, the STA may enable or instruct the peripheral device to scan a plurality of wireless channels to detect nearby APs on behalf of the STA, for example, to identify a given AP with which the STA may associate. The STA may receive a result of the scan from the peripheral device, and identify the AP based on the result of the scan. For example, the result may include a wireless channel associated with the AP (e.g., the wireless channel on which the AP operates). The STA may then perform a directed scan of the wireless channel to initiate the wireless connection exchange with the AP.

The methods of operation disclosed herein may free up communication and/or processing resources of a wireless station by leveraging the resources of a peripheral device. For example, by offloading some or all of the steps for setting up a wireless connection with an access point, the STA may perform other communications (e.g., off-channel scanning operations and/or communicating with other devices using another communication channel or protocol) and/or application processes while the peripheral device scans for access points or performs (at least a portion of) a wireless connection exchange with a target AP. This may also ensure that the wireless connection exchange with the target AP is completed, even if the process being performed on the STA is interrupted by other processes and/or communications.

### BRIEF DESCRIPTION OF THE DRAWINGS

The example embodiments are illustrated by way of example and are not intended to be limited by the figures of the accompanying drawings, where:

FIG. 1 shows a block diagram of a wireless system within which the example embodiments may be implemented.

FIG. 2 shows an example sequence diagram depicting an offloading of a wireless connection exchange between a wireless station (STA) and an access point (AP).

FIG. 3 shows an example timing diagram depicting a process for connecting a STA to an AP whereby the STA offloads a handshake operation to a peripheral device.

FIG. 4 shows an example timing diagram depicting a process for connecting a STA to an AP whereby the STA offloads a channel scanning operation to a peripheral device.

FIG. 5 shows a block diagram of a STA in accordance with example embodiments.

FIG. 6 shows a block diagram of a peripheral device in accordance with example embodiments.

FIG. 7 shows a block diagram of an AP in accordance with example embodiments.

FIG. 8 shows a flowchart depicting an example wireless connection exchange offloading operation.

FIG. 9 shows a flowchart depicting an example operation for offloading a handshake operation by a STA to a peripheral device.

FIG. 10 shows a flowchart depicting an example operation for offloading a wireless channel scanning operation by a STA to a peripheral device.

FIG. 11 shows a flowchart depicting an example operation for offloading a wireless channel scanning operation by an AP to a peripheral device.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, BLUETOOTH® (Bluetooth), HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example embodiments are equally applicable to other WLAN systems including, for example, multiple WLANs, peer-to-peer (or Independent Basic Service Set) systems, Wi-Fi Direct systems, and/or Hotspots.

In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. The term “target AP” refers to an AP with which a given STA intends to associate (e.g., there is not yet an established communication channel or link between the AP and the given STA). The term “wireless connection exchange” or “connection exchange” refers to a process by which a STA sets up and/or establishes a wireless connection with an AP (e.g., whereby the STA joins a WLAN associated with the AP).

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

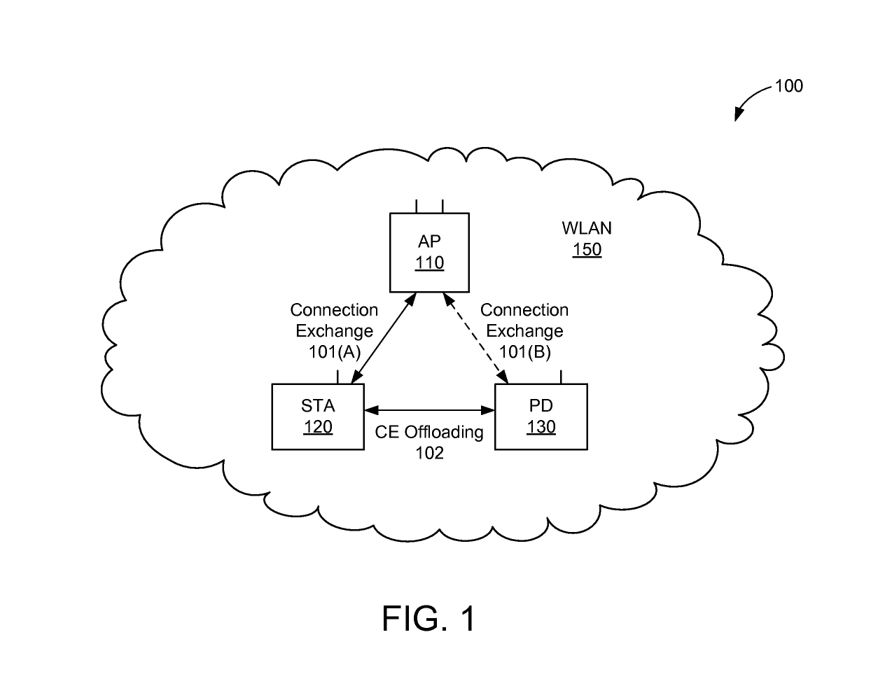

FIG. 1 is a block diagram of a wireless system 100 within which the example embodiments may be implemented. The wireless system 100 is shown to include a wireless access point (AP) 110, a wireless station (STA) 120, a peripheral device (PD) 130, and a wireless local area network (WLAN) 150. The WLAN 150 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 150 may be formed by any number of access points such as AP 110. Although the WLAN 150 is depicted in FIG. 1 as an infrastructure basic service set (BSS), for other example embodiments, WLAN 150 may be an independent basic service set (IBSS), an ad-hoc network, or a peer-to-peer (P2P) network (e.g., operating in accordance with the Wi-Fi Direct specification).

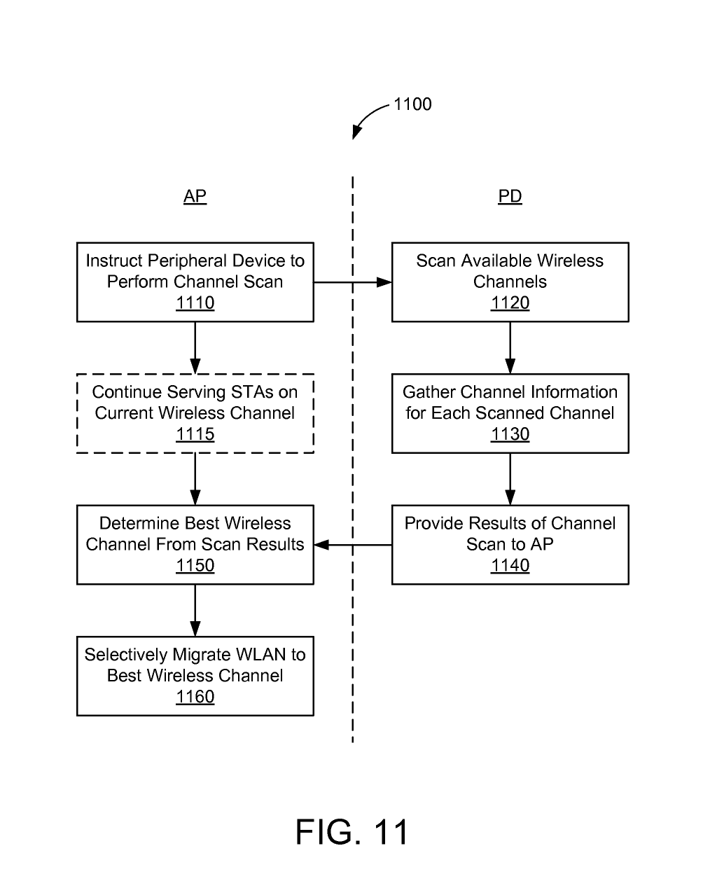

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. The AP 110 is assigned a unique media access control (MAC) address that is programmed therein by, for example, a device manufacturer. For some embodiments, the AP 110 may be any suitable wireless device (e.g., such as a wireless STA) acting as a software-enabled access point (“SoftAP”). For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 11.

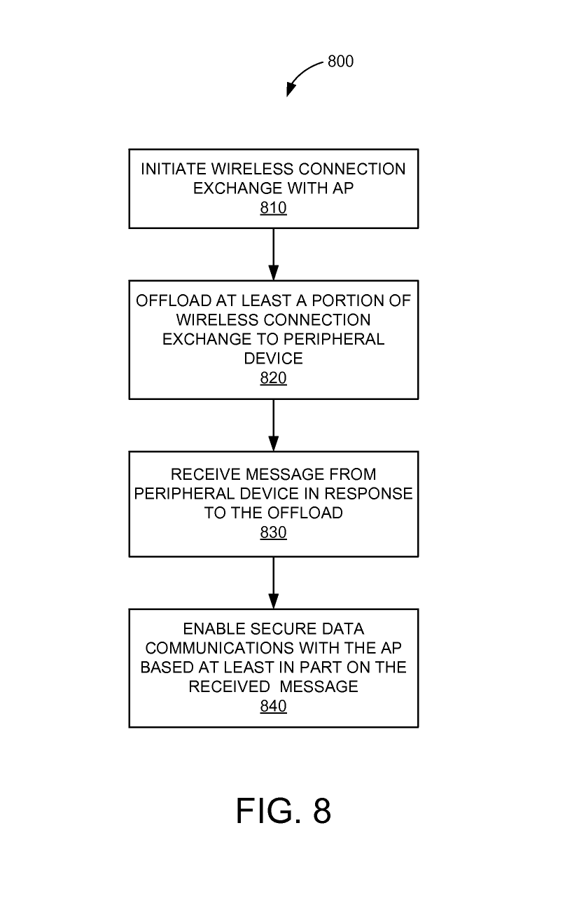

The STA 120 may be any suitable Wi-Fi enabled wireless device including, for example, a cell phone, personal digital assistant (PDA), tablet device, laptop computer, or the like. The STA 120 may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. The STA 120 is also assigned a unique MAC address. For at least some embodiments, the STA 120 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 8-10.

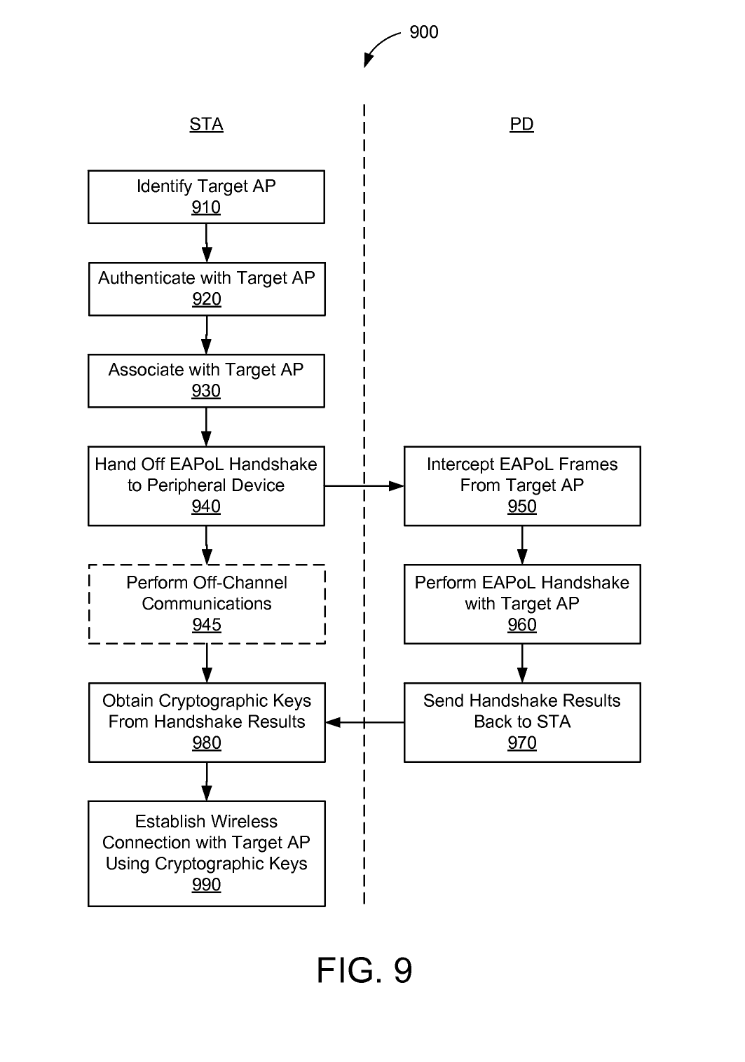

The peripheral device 130 may be any suitable device that can be tethered to (e.g., via a wired or wireless connection), or otherwise in communication with, the STA 120 and/or the AP 110. For example, the peripheral device 130 may be a wireless accessory device (e.g., a “smartwatch” or a tablet computer device) that is in constant communication with the STA 120 via a “secondary” communications link, and may further be configured to communicate with the AP 110 via a “primary” communications link (e.g., through WLAN 150). In example embodiments, the secondary communications link may follow a different communications protocol than that of the WLAN 150. For example, the secondary communications link may be a Bluetooth link, a near field communication (NFC) link, a Universal Serial Bus (USB), or any other wired or wireless link suitable for data communications. For at least some embodiments, the peripheral device 130 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 9-11.

For the AP 110, the STA 120, and/or the peripheral device 130, the one or more transceivers may include Wi-Fi transceivers, Bluetooth transceivers, NFC transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers may be any technically feasible transceiver such as a ZigBee transceiver described by the ZigBee specification, a WiGig transceiver, and/or a HomePlug transceiver described in a specification from the HomePlug Alliance

To establish a Wi-Fi connection between the STA 120 and the AP 110, the STA 120 may typically scan one or more wireless channels to first identify the AP 110 (e.g., and/or WLAN 150). For example, the STA 120 may perform a wireless channel scanning operation by broadcasting probe requests on each of a plurality of available wireless channels for the given communications standard (e.g., Wi-Fi channels 1-11 in the 2.4 GHz frequency band). The probe requests may indicate a number of communication capabilities supported by the STA 120. When the AP 110 receives a probe request from the STA 120, the AP 110 may respond by sending, to the STA 120, a probe response that mirrors the information provided in the probe request intersected with the capabilities supported by the AP 110.

The STA 120 may initiate a wireless connection exchange 101 with the AP 110 (e.g., shown as connection exchange 101(A) in FIG. 1) upon receiving a probe response from the AP 110. For example, the STA 120 may first initiate an authentication process by transmitting an authentication request to the AP 110. The authentication request may trigger a low-level authentication mechanism described by the IEEE 802.11 specification. The AP 110 responds to the authentication request by sending an authentication response back to the STA 120 to complete the authentication process. Once authenticated, the STA 120 may then send an association request to the AP 110. The association request may include one or more requested capabilities (e.g., under the IEEE 802.11 specification) to be used for data communications between the STA 120 and the AP 110. If the AP 110 is able to support the requested capabilities indicated in the association request, the AP 110 may create an Association ID (AID) for the STA 120 and send an association response back to the STA 120.

After the STA 120 and AP 110 are associated, the AP 110 may initiate a handshake operation with the STA 120. The handshake operation is used to generate dynamic keys for encrypting and decrypting data communications between the AP 110 and the STA 120. For example, the handshake operation may correspond to a 4-way handshake operation, as described in the IEEE 802.11 specification, whereby the STA 120 and the AP 110 exchange Extensible Authentication over Local Area Network (EAPoL) frames with one another to generate a Pairwise Transient Key (PTK) and/or other cryptographic keys to be used for data encryption (and decryption). The STA 120 is effectively “connected” to the AP 110 (and WLAN 150) once the handshake is completed (e.g., the STA 120 is enabled for data communications with the AP 110 and/or other devices in the WLAN 150).

As described above, the wireless connection exchange 101 is a relatively time-consuming process. In particular, the 4-way handshake operation is typically performed at a much lower data rate than other data or communication exchanges defined by the IEEE 802.11 specification. Thus, in some instances, the STA 120 may be interrupted (e.g., by other processes executing on the STA 120) before it is able to complete the connection exchange 101 with the AP 110. For example, the STA 120 may operate in a WLAN/Bluetooth “coexistence” mode. Because WLAN and Bluetooth radios may operate in the same frequency range (e.g., the 2.4 GHz spectrum), and often share antenna resources of the STA 120, a coexistence controller may selectively allocate time slots to each of the WLAN and Bluetooth radios of the STA 120.

For example, when the STA 120 is connected to an active Bluetooth accessory (e.g., a Bluetooth headset), the STA 120 may need to periodically communicate with the Bluetooth accessory to maintain the connection. However, if the STA 120 switches over to the Bluetooth channel before completing the connection exchange 101 with the AP 110, the STA 120 may need to subsequently repeat some or all of the steps in the connection exchange 101 to finish setting up a wireless connection with the AP 110. This may further prolong the connection exchange 101 and/or prevent the STA 120 from connecting to the AP 110 altogether.

In example embodiments, the STA 120 may offload some or all of the connection exchange 101 to the peripheral device 130. As described above, the peripheral device 130 may be a wireless accessory device, such as a smartwatch, that is in constant communication with the STA 120 via a secondary communications link. To conserve energy and preserve battery life, the secondary communications link may operate according to a low-power communications protocol (e.g., Bluetooth, NFC, USB, etc.).

The STA 120 may perform a connection exchange (CE) offloading 102 with the peripheral device 130, via the secondary communications link, to enable the peripheral device 130 to perform at least a portion of the connection exchange 101 with the AP 110 (e.g., shown as connection exchange 101(B) in FIG. 1). This allows the STA 120 to then go off-channel (e.g., to leave the primary communications link with the AP 110) and perform other processes and/or communications (e.g., communicate with a Bluetooth network and/or performing off-channel scanning operations). For some embodiments, the STA 120 may initiate the CE offloading 102 when it is about to perform other processes and/or communications (e.g., requiring the STA 120 to go off-channel).

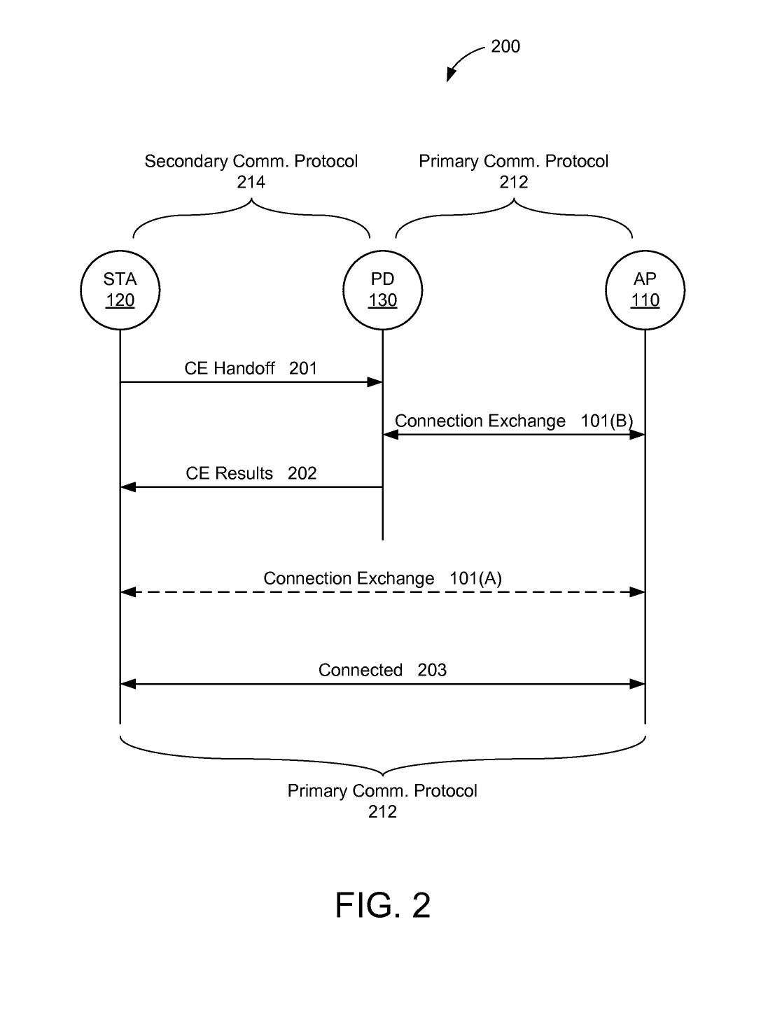

For example, with reference to the sequence diagram 200 of FIG. 2, the AP 110 may communicate with the STA 120 and the peripheral device 130 using a primary communications protocol 212 (e.g., Wi-Fi), while the STA 120 may communicate with the peripheral device 130 using a secondary communications protocol 214 (e.g., Bluetooth or NFC). The STA 120 may initiate the CE offloading process 102 by sending a CE handoff message 201 to the peripheral device 130. The CE handoff message 201 may include instructions for performing some or all of the connection exchange 101 on behalf of the STA 120. For example, the CE handoff message 201 may include information that can be used to identify the AP 110 (e.g., such as the MAC address of the AP 110, the SSID of the AP 110, and/or wireless channel associated with the WLAN 150) and/or information that can be used to intercept messages transmitted by the AP 110 (e.g., such as the MAC address and/or AID for the STA 120).

Upon receiving the CE handoff message 201, the peripheral device 130 may then act as a proxy for the STA 120 to perform the connection exchange 101 with the AP 110. The peripheral device 130 may provide updates to the STA 120, in the form of CE results message 202, based on the status of the connection exchange 101. The CE results message 202 may be communicated to the STA 120 using the secondary communications protocol 214, and may include any suitable connection information that allows the STA 120 to resume and/or complete the connection exchange 101 with the AP 110. Thus, when the STA 120 is ready to resume communications with the AP 110, the STA 120 may use the connection information contained in the CE results message 202 to either finish the connection exchange 101 with the AP 110 (e.g., based on where the peripheral device 130 left off) or connect directly 203 to the AP 110 (e.g., if the peripheral device 130 has already completed the connection exchange 101). For at least some embodiments, the CE results message 202 may include encryption keys and/or other information that allows the STA 120 to complete the procedure for establishing a wireless connection and/or initiate secure communications with the AP 110. More specifically, the STA 120 may receive a set of encryption keys from the peripheral device 130 in the CE results message 202, and may immediately begin using the set of encryption keys to encrypt or decrypt data communications with the AP 110.

To further preserve battery life, the peripheral device 130 may activate its primary radio (e.g., for communicating with the AP 110, using the primary communications protocol 212) only when instructed to do so by the STA 120. For example, the peripheral device 130 may activate its primary radio in response to receiving the CE handoff message 201 from the STA 120. The peripheral device 130 may then deactivate its primary radio upon completing the necessary portion of the connection exchange 101. Thus, while the peripheral device 130 is tethered to the STA 120, any subsequent communications between the peripheral device 130 and the AP 110 (e.g., and/or WLAN 150) may be routed to the STA 120, using the secondary communications protocol 214, and the STA 120 may route the communications to the AP 110 (e.g., using the primary communications protocol 213).

In the example embodiments, the STA 120 may leverage the communications capabilities of the peripheral device 130 to offload at least a portion of the connection exchange 101 with the AP 110 to the peripheral device 130. This may free up communication and/or processing resources of the STA 120, thus enabling the STA 120 to handle other application processes and/or communications while the connection exchange 101 is concurrently being performed between the AP 110 and the peripheral device 130 on behalf of the STA 120.

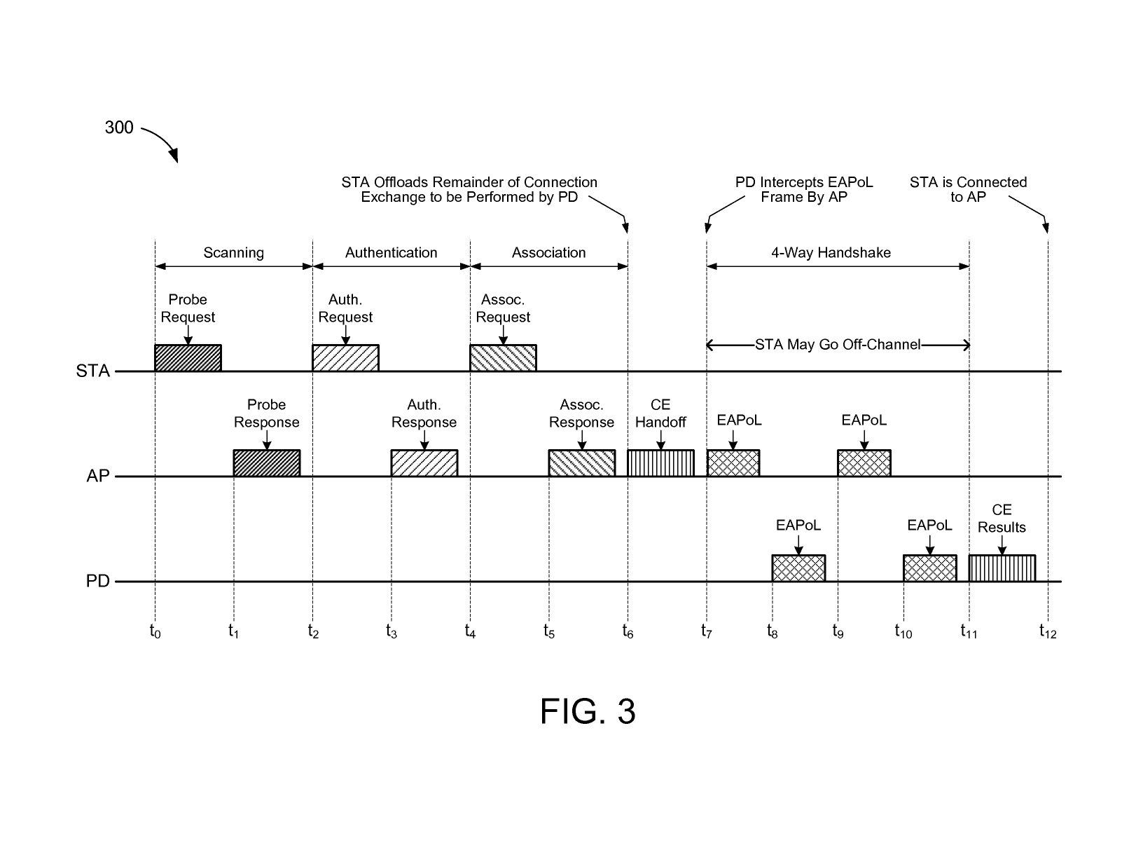

FIG. 3 shows an example timing diagram 300 depicting a process for connecting a STA to an AP whereby the STA offloads a handshake operation to a peripheral device. For purposes of discussion herein, the AP, STA, and peripheral device may be AP 110, STA 120, and peripheral device (PD) 130, respectively, of FIG. 1. The AP may operate on a particular Wi-Fi channel (e.g., in accordance with the IEEE 802.11 specification) and the peripheral device may be tethered to the STA via a secondary communications link.

The STA may initially scan for an access point with which to associate (e.g., from times t₀ to t₂). For example, the STA may broadcast a probe request on the Wi-Fi channel associated with the AP at time t₀. As described above, the probe request may indicate a number of communication capabilities supported by the STA. The AP responds to the probe request by sending a probe response back to the STA at time t₁. For example, the probe response may mirror the information provided in the probe request intersected with the capabilities supported by the AP.

To establish a Wi-Fi connection with the target AP, the STA and AP may need to authenticate (e.g., from times t₂ to t₄) and associate (e.g., from times t₄ to t₆) with one another. During authentication, the STA sends an authentication request to the AP at time t₂, and the AP sends an authentication response back to the STA time t₃. For example, the authentication process may correspond with a low-level authentication mechanism, as described by the IEEE 802.11 specification. During association, the STA sends an association request to the AP at time t₄, and the AP sends an association response back to the STA at time t₅. For example, the association process allows the STA and the AP to negotiate one or more capabilities to be used for subsequent wireless communications between the devices.

Once the devices are associated with one another, the STA may offload a remaining portion of the wireless connection exchange to be performed by the peripheral device. In example embodiments, the STA may utilize the peripheral device as a proxy for performing a 4-way handshake operation with the AP. This may allow the STA to go off-channel (e.g., to perform other processes and/or communications) while the peripheral device performs the 4-way handshake operation on behalf of the STA (e.g., from times t₇ to t₁₁). For example, the STA may send a CE handoff message to the peripheral device, at time t₆, instructing the peripheral device to perform the handshake operation with the AP on behalf of the STA. The CE handoff message may include information that can be used to identify the AP (e.g., the MAC address, the SSID, and/or Wi-Fi channel of the AP) and/or intercept EAPoL frames transmitted by the AP (e.g., which may include the MAC address and/or AID for the STA).

The AP may then perform a 4-way handshake operation (e.g., from times t₇ to t₁₁) with the peripheral device, acting on behalf of the STA, to complete the connection exchange. For example, the AP may initiate the 4-way handshake operation, upon successful association with the STA, by transmitting a first EAPoL frame on the Wi-Fi channel at time t₇. Although the EAPoL frame(s) may be intended for the STA, in example embodiments, the peripheral device may intercept each EAPoL frame transmitted by the AP (e.g., using the MAC address and/or AID of the STA). The first EAPoL frame may contain a nonce-value associated with the AP (e.g., ANonce), which may be used by the peripheral device to construct a Pairwise Transient Key (PTK) for encrypting and/or decrypting data communications with the AP.

The peripheral device responds to the first EAPoL frame by sending a second EAPoL frame to the AP at time t₈. The second EAPoL frame may contain a nonce-value associated with the STA and/or peripheral device (e.g., SNonce) as well as a message integrity code (MIC), which may be used by the AP to construct its own copy of the PTK for encrypting and/or decrypting data communications with the STA. The AP responds to the second EAPoL frame by sending a third EAPoL frame to the peripheral device at time t₉. The third EAPoL frame may contain a Group Temporal Key (GTK), which may be used by the STA (and other STAs in the network) to decrypt multicast or broadcast messages from the AP. The fourth and final EAPoL frame is sent by the peripheral device to the AP, at time t₁₀, to confirm reception of the GTK.

Upon completion of the 4-way handshake operation, at time t₁₁, the peripheral device may return a set of CE results back to the STA. The CE results may include the set of cryptographic keys (e.g., PTK and/or GTK) negotiated between the peripheral device and the AP. A Wi-Fi connection is effectively established between the STA and the AP once the STA receives the CE results from the peripheral device. Accordingly, the STA may be immediately configured for secure data communications with the AP (e.g., using the cryptographic keys), over the Wi-Fi channel, at time t₁₂.

The timing diagram 300 of FIG. 3 shows a wireless connection exchange (e.g., from times t₂ to t₁₂) whereby a handshake operation is offloaded to a peripheral device, for example purposes only. Alternatively and/or additionally, other portions of the connection exchange may be offloaded to the peripheral device. For example, in some embodiments, the STA may offload the authentication process (e.g., from times t₂ to t₄) or the association process (e.g., from times t₄ to t₆) to the peripheral device in addition to, or in lieu of, the 4-way handshake operation. In other embodiments, the peripheral device may perform the entire connection exchange on behalf of the STA.

Still further, in some embodiments, the STA may offload a wireless scanning operation to the peripheral device. As described above, the process of scanning all available wireless channels (e.g., to locate the best available access point with which to associate) is time-consuming and may prevent the STA from performing other processes and/or communications until the channel scanning operation is completed. Thus, the STA may free up processing and/or communications resources by using the peripheral device to scan the available wireless channels for access points (e.g., generic scanning). The STA may then identify the target AP based on a result of the channel scanning operation by the peripheral device, and perform a subsequent channel scanning operation on only the Wi-Fi channel upon which the target AP operates (e.g., directed scanning).

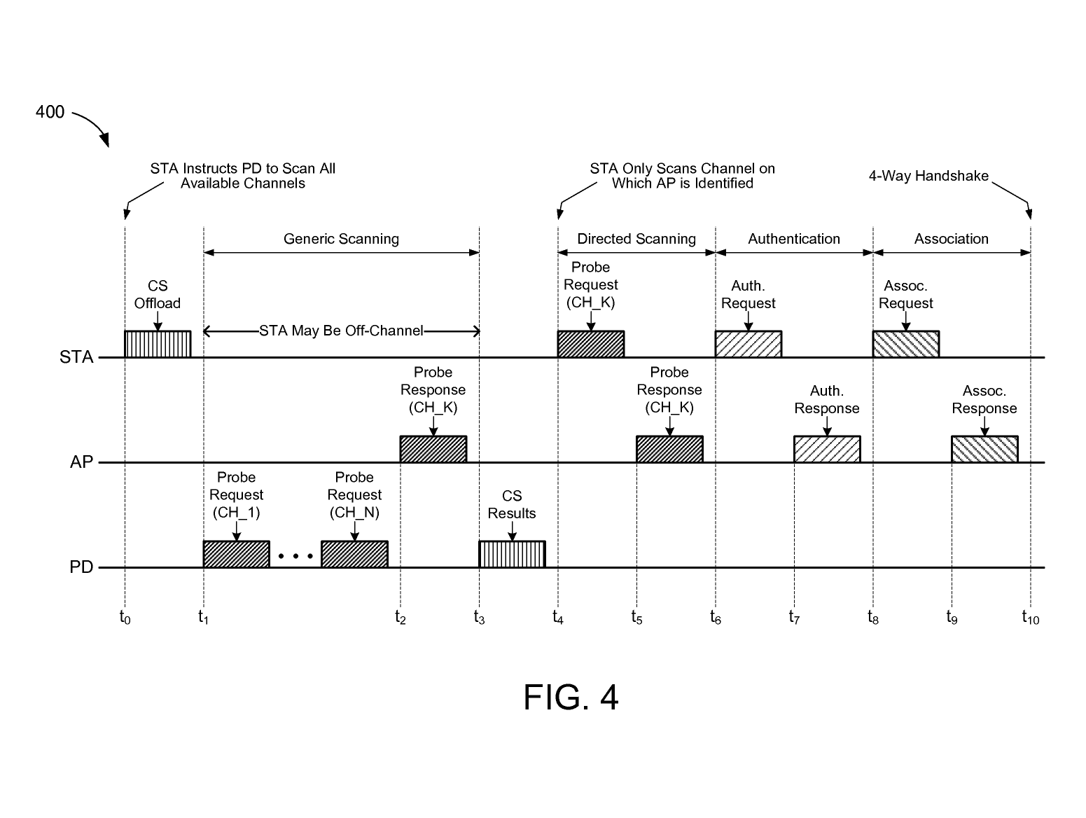

FIG. 4 shows an example timing diagram 400 depicting a process for connecting a STA to an AP whereby the STA offloads a channel scanning operation to a peripheral device. For purposes of discussion herein, the AP, STA, and peripheral device may be AP 110, STA 120, and peripheral device (PD) 130, respectively, of FIG. 1. The AP may operate a particular Wi-Fi channel (e.g., CH_K) and the peripheral device may be tethered to the STA via a secondary communications link.

The STA may initially offload a generic channel scanning operation to the peripheral device. For example, the STA may send a channel scan (CS) offload message to the peripheral device at time t₀. The CS offload message may include instructions, and any necessary information (e.g., pertaining to the capabilities of the STA), for identifying and/or scanning all available channels (e.g., CH_1-CH_N) for the given wireless communications protocol (e.g., according to the IEEE 802.11 specification). By using the peripheral device as a proxy for performing the generic channel scanning operation, the STA may go off-channel (e.g., to perform other processes and/or communications) while the peripheral device performs the generic scanning operation on behalf of the STA (e.g., from times t₁ to t₂).

The peripheral device may then perform the generic channel scanning operation (e.g., from times t₁ to t₃) on behalf of the STA. For example, the peripheral device may begin broadcasting probe requests on each of the available channels CH_1-CH_N at time t₁. The probe request may indicate a number of communication capabilities supported by the peripheral device (and/or by the STA). If an access point is available on a scanned channel, the access point may respond to the probe request by sending a probe response back to the peripheral device. In the example of FIG. 4, the target AP (e.g., which operates on channel CH_K) responds to the probe request sent over channel CH_K by sending a probe response back to the peripheral device at time t₂. For example, the probe response may mirror the information provided in the probe request intersected with the capabilities supported by the target AP.

Upon completion of the generic channel scanning operation, at time t₃, the peripheral device may return a set of CS results back to the STA. The CS results may include a list of access points that were detected by the peripheral device, including information identifying each access point and/or wireless channel information associated with each access point. The STA may then identify the target AP from the list of access points provided with the CS results and proceed to set up a connection with the target AP.

In example embodiments, the STA may identify the wireless channel associated with the target AP from the CS results. The STA may then perform a directed scanning operation (e.g., from times t₄ to t₆) on that particular channel (e.g., CH_K) to more accurately determine which capabilities of the STA are actually supported by the target AP. More specifically, the directed scanning operation may be targeted specifically to the target AP. For example, the STA may broadcast a probe request on channel CH_K, only, at time t₄. The probe request may indicate a number of communication capabilities specifically supported by the STA. The target AP responds to the probe request by sending a probe response back to the STA at time t₅. As described above, the probe response may mirror the information provided in the probe request intersected with the capabilities supported by the target AP.

Finally, the STA may perform a wireless connection exchange with the target AP to enable secure data communications between the devices. For example, the STA may send an authentication request to the target AP at time t₆, and the target AP may send an authentication response back to the STA at time t₇. The authentication process may correspond to a low-level authentication process described by the IEEE 802.11 specification. The STA may then send an association request to the target AP at time t₈, and the target AP may send an association response back to the STA at time t₉. The association process allows the STA and the target AP to negotiate one or more capabilities to be used for subsequent wireless communications between the devices.

Once the STA and the target AP are associated with one another, at time t₁₀, the STA may then perform a 4-way handshake operation with the target AP to complete the wireless connection exchange. The 4-way handshake operation is to negotiate a set of cryptographic keys that may be used to encrypt and decrypt data communications between the STA and the target AP. In some embodiments, the STA may offload the 4-way handshake operation to the peripheral device (e.g., as described above with respect to FIG. 3). This may allow the STA additional time to perform other processes and/or communications, for example, while the peripheral device performs the 4-way handshake operation on behalf of the STA.

In some embodiments, the AP may similarly offload a channel scanning operation to a peripheral device tethered to, or otherwise in communication with, the AP (not shown in FIG. 4 for simplicity). For example, the AP (e.g., which may be a software-enabled AP (SoftAP) or peer-to-peer group owner (P2P-GO)), may periodically search for a new wireless channel (e.g., a wireless channel with less noise and/or interference than the current wireless channel associated with the AP). When searching for a new wireless channel, the AP typically scans all of the available wireless channels (e.g., CH_1-CH_N) to find a better-quality wireless channel than the current wireless channel (e.g., CH_K). However, in conventional implementations, the AP typically would leave its current channel in order to scan the other wireless channels. As a result, the AP would have to temporarily suspend communications with any client STAs connected to the WLAN, thereby causing data queues on the AP and/or STAs to become backlogged.

In example embodiments, the AP may use a peripheral device as a proxy to perform the channel scanning operation (e.g., in a substantially similar manner as described above with respect to FIG. 4). For example, the AP may instruct the peripheral device to perform the channel scanning operation via a secondary communications link (e.g., which may correspond with a Bluetooth, NFC, USB, or other wired or wireless connection) between the AP and the peripheral device. The peripheral device may then scan the available wireless channels and collect channel information such as, for example, channel occupancy (e.g., the number of BSSs operating on each channel), signal strength (e.g., received signal strength indicator (RSSI) information for each channel), and/or traffic distribution (e.g., the amount of data traffic or wireless activity on each channel).

While the peripheral device is performing the channel scanning operation on behalf of the AP, the AP may perform other processes and/or communications (e.g., by providing continuous or undisrupted service to the client STAs). The peripheral device may then send the channel information (e.g., the results of the channel scan) back to the AP, via the secondary communications link. The AP may compare and/or weigh the channel information to determine whether its WLAN may benefit from moving to a different wireless channel. If the AP identifies a better-quality channel, the AP may migrate the WLAN over to the new wireless channel (e.g., by tuning its Wi-Fi radio to the new channel and instructing any client STAs to do the same).

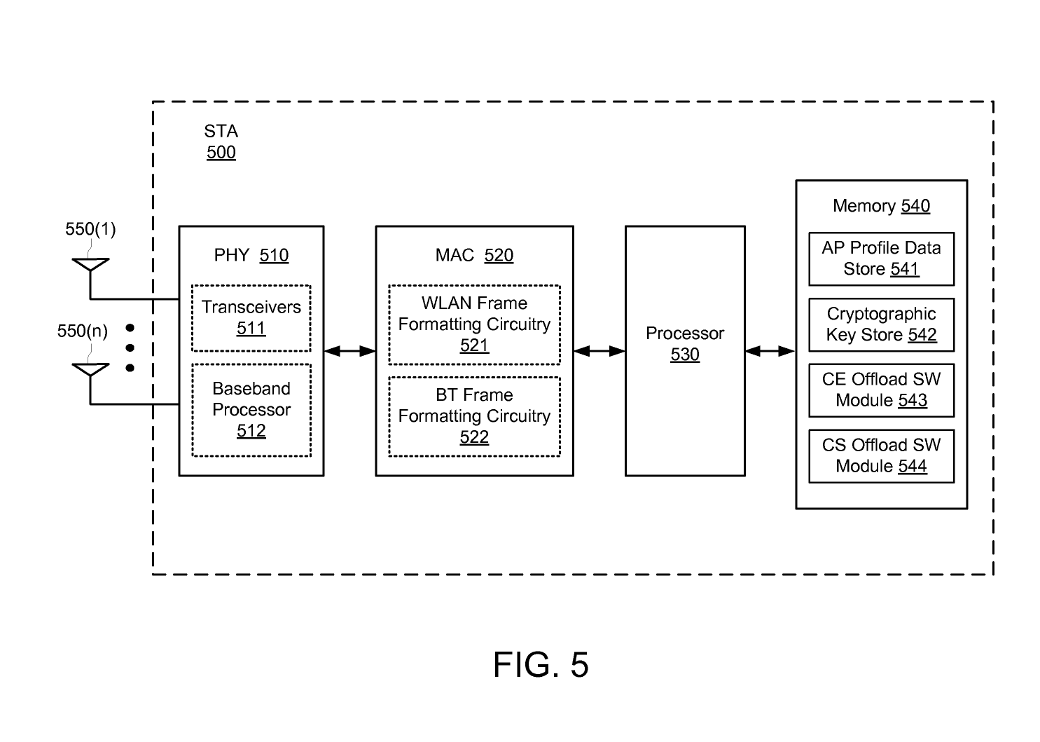

FIG. 5 shows a block diagram of a STA 500 in accordance with example embodiments. The STA 500 may be one embodiment of the STA 120 of FIG. 1. The STA 500 includes at least a PHY device 510, a MAC 520, a processor 530, memory 540, and a number of antennas 550(1)-550(n). For purposes of discussion herein, the MAC 520 is shown as being coupled between the PHY device 510 and processor 530. However, for actual embodiments, PHY device 510, MAC 520, processor 530, and/or memory 540 may be connected together using one or more buses (not shown for simplicity).

The PHY device 510 includes at least a set of transceivers 511 and a baseband processor 512. The transceivers 511 may be coupled to antennas 550(1)-550(n), either directly or through an antenna selection circuit (not shown for simplicity). The transceivers 511 may be used to transmit signals to and receive signals from other wireless devices (e.g., APs, STAs, and/or peripheral devices), and may be used to scan the surrounding environment to detect and identify nearby wireless devices (e.g., within wireless range of the STA 500). In example embodiments, the transceivers 511 may include Bluetooth transceivers (e.g., configured to transmit and receive wireless signals in accordance with Bluetooth protocols) and Wi-Fi transceivers (e.g., configured to transmit and receive wireless signals in accordance with Wi-Fi protocols). The baseband processor 512 may be used to process signals received from processor 530 and/or memory 540 and to forward the processed signals to transceivers 511 for transmission via one or more antennas 550(1)-550(n). The baseband processor 512 may also be used to process signals received from one or more antennas 550(1)-550(n) via transceivers 511 and to forward the processed signals to the processor 530 and/or memory 540.

The MAC 520 includes at least WLAN frame formatting circuitry 521 and Bluetooth (BT) frame formatting circuitry 522. The WLAN frame formatting circuitry 521 may be used to create and/or format frames received from the processor 530 and/or memory 540 (e.g., by adding MAC headers to data packets provided by processor 530), and re-format frames received from the PHY device 510 (e.g., by stripping MAC headers from frames received from the PHY device 510), in accordance with a Wi-Fi specification. The BT frame formatting circuitry 522 may be used to create and/or format frames received from the processor 530 and/or memory 540, and re-format frames received from the PHY device 510, in accordance with a Bluetooth specification. For some embodiments, the WLAN frame formatting circuitry 521 and/or the BT frame formatting circuitry 522 may be implemented as one or more software modules (e.g., stored in memory 540 or stored in memory provided within the MAC 520) containing instructions that, when executed by processor 530, perform the functions of the WLAN frame formatting circuitry 521 and/or the BT frame formatting circuitry 522.

Memory 540 may include an AP profile data store 541 that stores profile information for one or more APs, and may include a cryptographic key store 542 that stores associated cryptographic key information for the one or more APs. The profile information for a particular AP may include information such as, for example, the AP's service set identifier (SSID), the AP's MAC address, channel information, RSSI values, goodput values, channel state information (CSI), supported data rates, connection history with the STA 500, a trustworthiness value of the AP (e.g., indicating a level of confidence about the AP's location, etc.), and any other suitable information pertaining to or describing the operation of the AP. The cryptographic key information may include a set of cryptographic keys (e.g., PTK and/or GTK) that may be used for secure data communications with a particular AP.

Memory 540 may also include a non-transitory computer-readable medium (e.g., one or more nonvolatile memory elements, such as EPROM, EEPROM, Flash memory, a hard drive, etc.) that may store at least the following software (SW) modules:
a connection exchange (CE) offload SW module 543 to offload at least a portion of a wireless connection exchange, between the STA 500 and an AP, to a peripheral device; and
a channel scanning (CS) offload SW module 544 to offload at least a portion of a channel scanning operation to the peripheral device.
   Each software module includes instructions that, when executed by processor 530, causes the STA 500 to perform the corresponding functions. The non-transitory computer-readable medium of memory 540 thus includes instructions for performing all or a portion of the STA-side operations depicted in FIGS. 8-10.

Processor 530 may be any suitable one or more processors capable of executing scripts or instructions of one or more software programs stored in the STA 500 (e.g., within memory 540). For example, processor 530 may execute the CE offload SW module 543 to offload at least a portion of a wireless connection exchange, between the STA 500 and an AP, to a peripheral device. The processor 530 may also execute the CS offload SW module 544 to offload at least a portion of a channel scanning operation to be performing by the peripheral device.

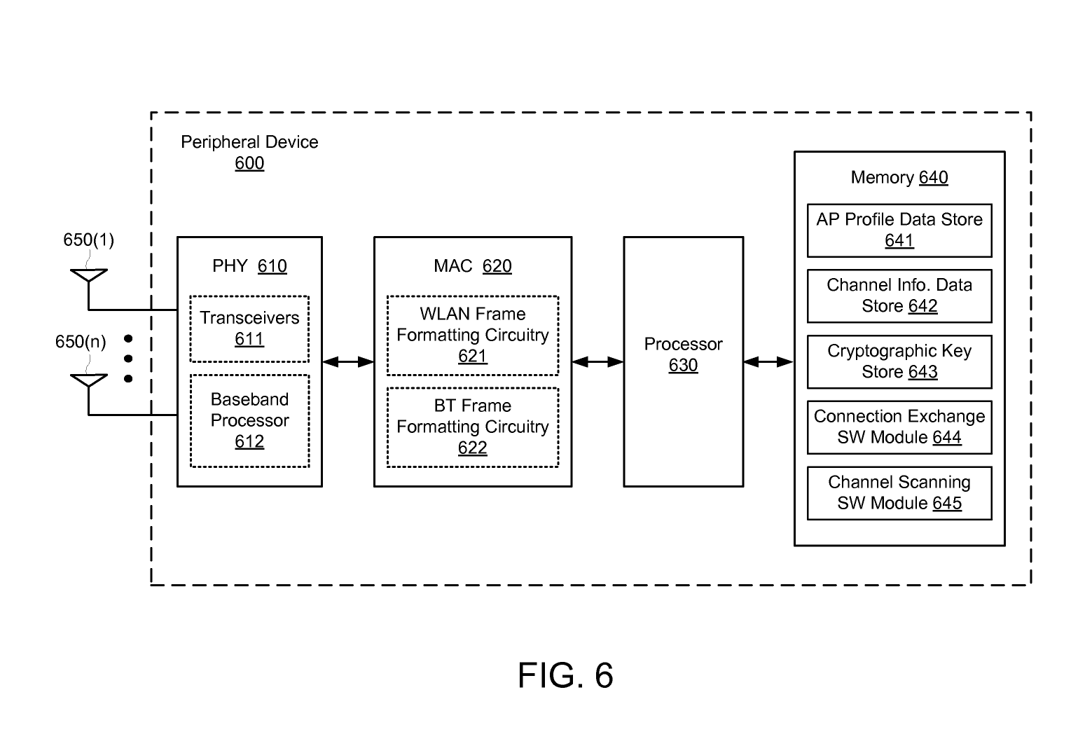

FIG. 6 shows a block diagram of a peripheral device 600 in accordance with example embodiments. The peripheral device 600 may be one embodiment of the peripheral device 130 of FIG. 1. The peripheral device 600 includes at least a PHY device 610, a MAC 620, a processor 630, memory 640, and a number of antennas 650(1)-650(n). For purposes of discussion herein, the MAC 620 is shown as being coupled between the PHY device 610 and processor 630. However, for actual embodiments, PHY device 610, MAC 620, processor 630, and/or memory 640 may be connected together using one or more buses (not shown for simplicity).

The PHY device 610 includes at least a set of transceivers 611 and a baseband processor 612. The transceivers 611 may be coupled to antennas 650(1)-650(n), either directly or through an antenna selection circuit (not shown for simplicity). The transceivers 611 may be used to transmit signals to and receive signals from other wireless devices (e.g., APs and/or STAs), and may be used to scan the surrounding environment to detect and identify nearby wireless devices (e.g., within wireless range of the peripheral device 600). In example embodiments, the transceivers 611 may include Bluetooth transceivers and Wi-Fi transceivers. The baseband processor 612 may be used to process signals received from processor 630 and/or memory 640 and to forward the processed signals to transceivers 611 for transmission via one or more antennas 650(1)-650(n). The baseband processor 612 may also be used to process signals received from one or more antennas 650(1)-650(n) via transceivers 611 and to forward the processed signals to the processor 630 and/or memory 640.

The MAC 620 includes at least WLAN frame formatting circuitry 621 and BT frame formatting circuitry 622. The WLAN frame formatting circuitry 621 may be used to create and/or format frames received from the processor 630 and/or memory 640, and re-format frames received from the PHY device 610, in accordance with a Wi-Fi specification. The BT frame formatting circuitry 622 may be used to create and/or format frames received from the processor 630 and/or memory 640, and re-format frames received from the PHY device 610, in accordance with a Bluetooth specification. For some embodiments, the WLAN frame formatting circuitry 621 and/or the BT frame formatting circuitry 622 may be implemented as one or more software modules (e.g., stored in memory 640 or stored in memory provided within the MAC 620) containing instructions that, when executed by processor 630, perform the functions of the WLAN frame formatting circuitry 621 and/or the BT frame formatting circuitry 622.

Memory 640 may include an AP profile data store 641 that stores profile information for one or more APs, a channel information data store 642, and may include a cryptographic key store 643 that stores associated cryptographic key information for the one or more APs. The profile information for a particular AP may include information such as, for example, the AP's SSID, the AP's MAC address, channel information, RSSI values, goodput values, CSI, supported data rates, connection history with a STA tethered to the peripheral device 600 (not shown for simplicity), a trustworthiness value of the AP, and any other suitable information pertaining to or describing the operation of the AP. The channel information may include channel occupancy, signal strength, traffic distribution, and/or other information that may be used to determine or predict the quality of communications over a given channel. The cryptographic key information may include a set of cryptographic keys (e.g., PTK and/or GTK) that may be used for secure data communications with a particular AP.

Memory 640 may also include a non-transitory computer-readable medium (e.g., one or more nonvolatile memory elements, such as EPROM, EEPROM, Flash memory, a hard drive, etc.) that may store at least the following software (SW) modules:
a connection exchange SW module 644 to perform at least a portion of a wireless connection exchange with an AP on behalf of a STA tethered to the peripheral device 600; and
a channel scanning SW module 645 to perform at least a portion of a channel scanning operation on behalf of a STA or an AP tethered to the peripheral device 600.
   Each software module includes instructions that, when executed by processor 630, causes the peripheral device 600 to perform the corresponding functions. The non-transitory computer-readable medium of memory 640 thus includes instructions for performing all or a portion of the PD-side operations depicted in FIGS. 9-11.

Processor 630 may be any suitable one or more processors capable of executing scripts or instructions of one or more software programs stored in the peripheral device 600 (e.g., within memory 640). For example, processor 630 may execute the connection exchange SW module 644 to perform at least a portion of a wireless connection exchange with an AP on behalf of a STA tethered to the peripheral device 600. The processor 630 may also execute the channel scanning SW module 645 to perform at least a portion of a channel scanning operation on behalf of a STA or an AP tethered to the peripheral device 600.

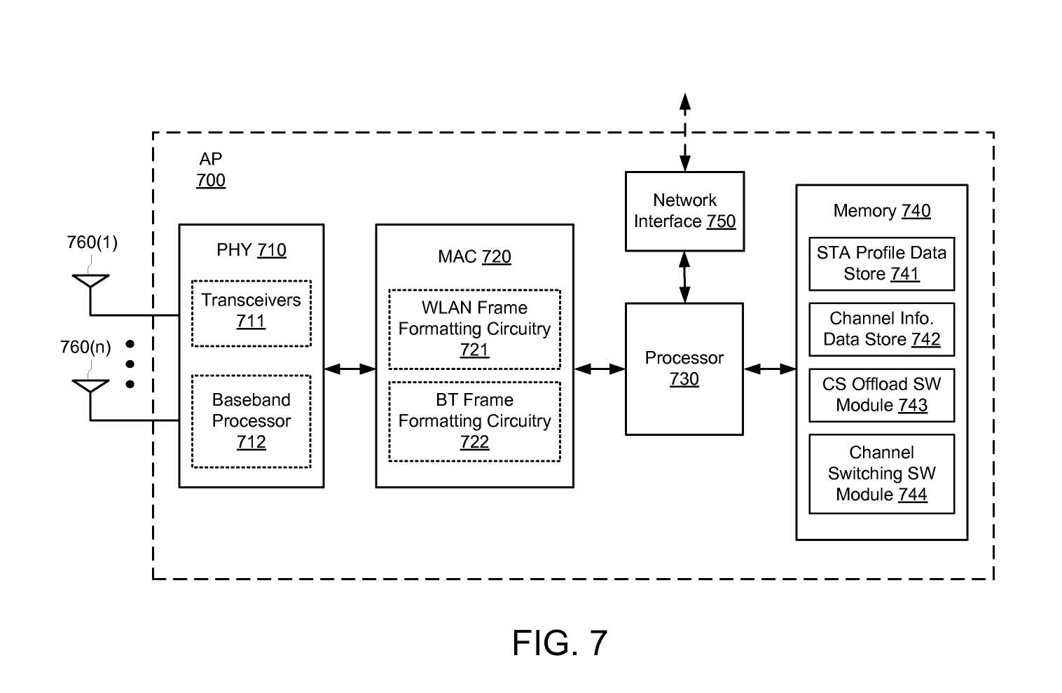

FIG. 7 shows a block diagram of an AP 700 in accordance with example embodiments. The AP 700 may be one embodiment of the AP 110 of FIG. 1. The AP 700 includes at least a PHY device 710, a MAC 720, a processor 730, memory 740, a network interface 750, and a number of antennas 760(1)-760(n). The network interface 750 may be used to communicate with a WLAN server (not shown for simplicity) either directly or via one or more intervening networks, and to transmit signals. For purposes of discussion herein, the MAC 720 is shown as being coupled between the PHY device 710 and processor 730. However, for actual embodiments, PHY device 710, MAC 720, processor 730, memory 740, and/or network interface 750 may be connected together using one or more buses (not shown for simplicity).

The PHY device 710 includes at least a set of transceivers 711 and a baseband processor 712. The transceivers 711 may be coupled to antennas 760(1)-760(n), either directly or through an antenna selection circuit (not shown for simplicity). The transceivers 711 may be used to transmit signals to and receive signals from other wireless devices (e.g., APs and/or STAs), and may be used to scan the surrounding environment to detect and identify nearby wireless devices (e.g., within wireless range of the AP 700). In example embodiments, the transceivers 711 may include Bluetooth transceivers and Wi-Fi transceivers. The baseband processor 712 may be used to process signals received from processor 730 and/or memory 740 and to forward the processed signals to transceivers 611 for transmission via one or more antennas 760(1)-760(n). The baseband processor 712 may also be used to process signals received from one or more antennas 760(1)-760(n) via transceivers 711 and to forward the processed signals to the processor 730 and/or memory 740.

The MAC 720 includes at least WLAN frame formatting circuitry 721 and BT frame formatting circuitry 722. The WLAN frame formatting circuitry 721 may be used to create and/or format frames received from the processor 730 and/or memory 740, and re-format frames received from the PHY device 710, in accordance with a Wi-Fi specification. The BT frame formatting circuitry 722 may be used to create and/or format frames received from the processor 730 and/or memory 740, and re-format frames received from the PHY device 710, in accordance with a Bluetooth specification. For some embodiments, the WLAN frame formatting circuitry 721 and/or the BT frame formatting circuitry 722 may be implemented as one or more software modules (e.g., stored in memory 740 or stored in memory provided within the MAC 720) containing instructions that, when executed by processor 730, perform the functions of the WLAN frame formatting circuitry 721 and/or BT frame formatting circuitry 722.

Memory 740 may include a STA profile data store 741 that stores profile information for one or more client STAs, and may include a channel information data store 742 that stores channel information for a plurality of available wireless channels. The profile information for a particular STA may include information such as, for example, the STA's MAC address, supported data rates, connection history with the AP 700, and any other suitable information pertaining to or describing the operation of the STA. The channel information may include channel occupancy, signal strength, traffic distribution, and/or other information that may be used to determine or predict the quality of communications over a given channel.

Memory 740 may also include a non-transitory computer-readable medium (e.g., one or more nonvolatile memory elements, such as EPROM, EEPROM, Flash memory, a hard drive, etc.) that may store at least the following software (SW) modules:
a channel scanning (CS) offload SW module 743 to offload at least a portion of a channel scanning operation to a peripheral device; and
a channel switching SW module 744 to determine whether to migrate a WLAN associated with the AP 700 to a new wireless channel based at least in part on a result of the channel scanning operation.
   Each software module includes instructions that, when executed by processor 730, causes the AP 700 to perform the corresponding functions. The non-transitory computer-readable medium of memory 740 thus includes instructions for performing all or a portion of the AP-side operations depicted in FIG. 11.

Processor 730 may be any suitable one or more processors capable of executing scripts or instructions of one or more software programs stored in the AP 700 (e.g., within memory 740). For example, processor 730 may execute the CS offload SW module 743 to offload at least a portion of a channel scanning operation to a peripheral device. The processor 730 may also execute the channel switching SW module 744 to determine whether to migrate a WLAN associated with the AP 700 to a new wireless channel based at least in part on a result of the channel scanning operation.

FIG. 8 shows a flowchart depicting an example wireless connection exchange offloading operation 800. With reference, for example, to FIG. 1, the example operation 800 may be performed by the STA 120 to offload at least a portion of a wireless connection exchange (e.g., with the AP 110) to the peripheral device 130.

The STA 120 may first initiate a wireless connection exchange with the AP 110 (810). The wireless connection exchange may be a process by which the STA 120 connects to, or otherwise establishes a secure wireless connection with, the AP 110 (and/or WLAN 150). More specifically, the wireless connection exchange may involve a back-and-forth exchange of messages between the AP 110 and STA 120 (e.g., or peripheral device 130 acting as a proxy for the STA 120, as described below) in order to negotiate a set of communication parameters. In some embodiments, the STA 120 may initiate the wireless connection exchange 101 with the AP 110 by transmitting an authentication request to the AP 110. The authentication request may trigger a low-level authentication mechanism, as described the by the IEE 802.11 specification.

The STA 120 may offload at least a portion of the wireless connection exchange to the peripheral device 130 (820). For example, with reference to FIG. 2, the STA 120 may initiate the CE offloading process 102 by sending a CE handoff message 201 to the peripheral device 130 (e.g., using the secondary communications protocol 214). The CE handoff message 201 may include instructions for performing some or all of the connection exchange 101 on behalf of the STA 120. For example, the CE handoff message 201 may include information to identify the AP 110 (e.g., such as the MAC address of the AP 110 and/or wireless channel associated with the WLAN 150) and/or information that can be used to intercept messages transmitted by the AP 110 (e.g., such as the MAC address and/or AID of the STA 120). Upon receiving the CE handoff message 201, the peripheral device 130 may then act as a proxy for the STA 120 to perform the connection exchange 101 with the AP 110.

The STA 120 may subsequently receive a message from the peripheral device 130 (830). For example, referring back to FIG. 2, the peripheral device 130 may provide updates to the STA 120, in the form of CE results message 202, based on the status of the connection exchange 101. The CE results message 202 may be communicated to the STA 120 using the secondary communications protocol 214, and may include any suitable information that allows the STA 120 to resume and/or complete the connection exchange 101 with the AP 110, for example, to establish a wireless connection between the STA 120 and the AP 110.

Finally, the STA 120 may enable secure data communications with the AP 110 based at least in part on the message received from the peripheral device 130 (840). For some embodiments, the peripheral device 130 may perform only a portion of the connection exchange 101 (e.g., without completing it). Accordingly, the STA 120 may use the connection information contained in the CE results message 202 to finish or complete the connection exchange 101 with the AP 110 (e.g., based on where the peripheral device 130 left off). In other embodiments, the peripheral device 130 may complete the connection exchange 101 (e.g., or perform the entire connection exchange 101) on behalf of the STA 120. Accordingly, the STA 120 may connect directly to the AP 110 using the connection information contained in the CE results message 202.

FIG. 9 shows a flowchart depicting an example operation 900 for offloading a handshake operation by a STA to a peripheral device. With reference, for example, to FIG. 3, the operation 900 may be performed by the STA to offload the 4-way handshake operation, during a connection exchange with the AP (hereinafter, the target AP), to the peripheral device.

The STA may first identify the target AP (910). For example, the STA may scan for the target AP by broadcasting a probe request on the Wi-Fi channel associated with the target AP at time t₀. The probe request may indicate a number of communication capabilities supported by the STA. The target AP may respond to the probe request by sending a probe response back to the STA at time t₁. The probe response may mirror the information provided in the probe request intersected with the capabilities supported by the target AP.

The STA may then authenticate with the target AP (920). For example, the STA may send an authentication request to the target AP at time t₂, and the target AP may send an authentication response back to the STA at time t₃. The authentication request may correspond with a low-level authentication mechanism, as described by the IEE 802.11 specification.

The STA may then associate with the target AP (930). For example, the STA may send an association request to the target AP at time t₄, and the target AP may send an association response back to the STA at time t₅. The association process allows the STA and the target AP to negotiate one or more capabilities to be used for subsequent wireless communications between the devices.

Once the devices are associated with one another, the STA may hand off an EAPoL handshake operation to the peripheral device (940). For example, the STA may send a CE handoff message to the peripheral device, at time t₆, instructing the peripheral device to perform the handshake operation with the target AP on behalf of the STA. The CE message may include information that can be used to identify the target AP and/or intercept EAPoL frames transmitted by the target AP. For some embodiments, after handing off the EAPoL handshake operation to the peripheral device, the STA may then go off-channel to perform other processes and/or communications (945). The target AP may initiate the EAPoL handshake operation upon successful association with the STA by transmitting an EAPoL frame on a corresponding Wi-Fi channel at time t₇.

The peripheral device may intercept each EAPoL frame from the target AP (950), and perform the EAPoL handshake operation on behalf of the STA (960). For example, the first EAPoL frame transmitted by the target AP (e.g., at time t₇) may contain a nonce-value associated with the AP. The peripheral device may use the nonce-value to construct the PTK for encrypting and/or decrypting data communications with the target AP. The peripheral device responds to the first EAPoL frame by sending a second EAPoL frame to the target AP at time t₈. The second EAPoL frame may contain a nonce-value associated with the STA and/or peripheral device as well as a MIC, which may be used by the target AP to construct its own copy of the PTK for encrypting and/or decrypting data communications with the STA. The AP responds to the second EAPoL frame by sending a third EAPoL frame to the peripheral device at time t₉. The third EAPoL frame may contain a GTK for decrypting multicast or broadcast messages from the AP. Finally, the peripheral device may send a fourth EAPoL frame to the AP, at time t₁₀, to confirm reception of the GTK.

Upon completing the EAPoL handshake operation with the AP, the peripheral device may return a set of handshake results to the STA (970). For example, the handshake results may include the set of cryptographic keys (e.g., PTK and/or GTK) negotiated between the peripheral device and the AP. In the example of the FIG. 3, the peripheral device sends the handshake results to the STA, at time t₁₁, as a set of CE results. For at least some embodiments, the peripheral device may embed the handshake results (and/or other suitable connection information) into a CE results message 202, and then send the results message 202 to the STA.

Finally, the STA may obtain, extract, and/or derive the cryptographic keys from the handshake results contained in the results message 202 (980), and thereafter communicate directly with the target AP using the cryptographic keys (990). As described above, a Wi-Fi connection is effectively established between the STA and the AP once the STA receives the handshake results from the peripheral device. Thus, after obtaining the cryptographic keys, the STA may be immediately configured for secure data communications with the AP (e.g., using the cryptographic keys), at time t₁₂.

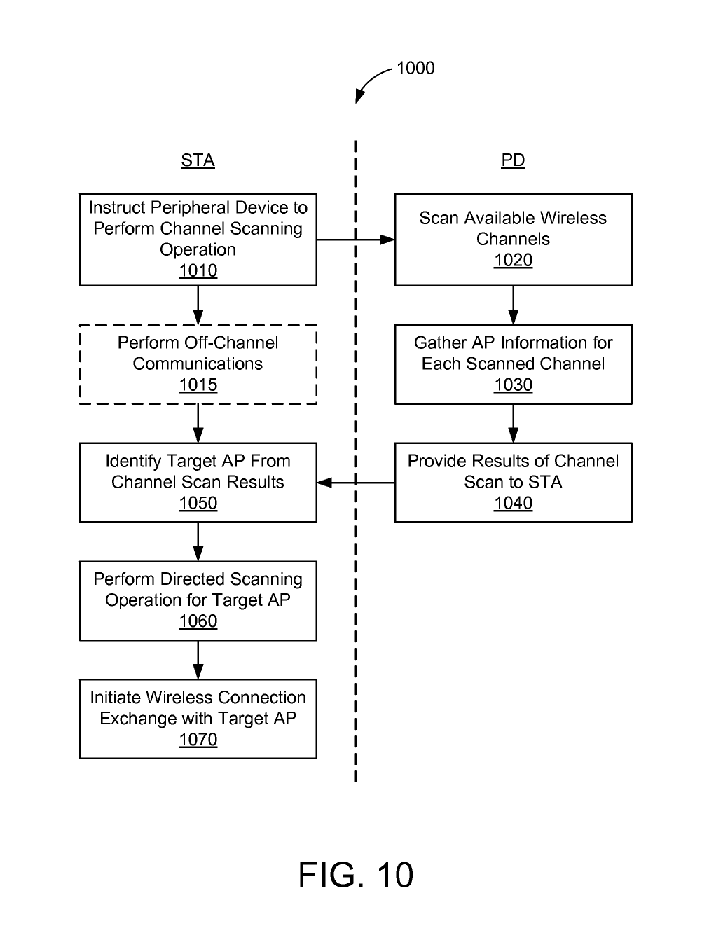

FIG. 10 shows a flowchart depicting an example operation 1000 for a STA offloading a wireless channel scanning operation to a peripheral device. With reference, for example, to FIG. 4, the operation 1000 may be performed by the STA to offload the generic channel scanning operation to the peripheral device.

The STA may initially instruct the peripheral device to perform a channel scanning operation (1010). For example, the STA may send a CS offload message to the peripheral device at time t₀. The CS offload message may include instructions, and any necessary information (e.g., pertaining to the capabilities of the STA), for identifying and/or scanning all available channels (e.g., CH_1-CH_N) for the given wireless communications protocol. For some embodiments, after handing off the channel scanning operation to the peripheral device, the STA may then go off-channel to perform other processes and/or communications (1015).

The peripheral device may then perform a scan of the available wireless channels on behalf of the STA (1020). For example, the peripheral device may begin broadcasting probe requests on each of the available channels CH_1-CH_N at time t₁. The probe request may indicate a number of communication capabilities supported by the peripheral device (and/or by the STA). If an access point is available on a scanned channel, the access point may respond to the probe request by sending a probe response back the peripheral device.

The peripheral device may gather AP information for each scanned channel (1030). For example, the probe responses sent by the access points may include information identifying the access points and/or their respective capabilities. More specifically, each probe response may mirror the information provided in the probe request intersected with the capabilities supported by the access point. In example embodiments, the peripheral device may accumulate a list of access points detected during the channel scanning operation.

Upon completing the channel scanning operation, the peripheral device may provide a set of channel scan results to the STA (1040). For example, the channel scan results may include the list of access points detected by the peripheral device, including information identifying each access point and/or wireless channel information associated with each access point. In the example of the FIG. 4, the peripheral device sends the channel scan results to the STA, at time t₃, as a set of CS results.

The STA may identify the target AP from the channel scan results received from the peripheral device (1050). In the example of FIG. 4, the target AP operates on channel CH_K. Accordingly, the target AP responds to the probe request transmitted on channel CH_K by sending a probe response back to the peripheral device, at time t₂. Thus, the STA may identify the target AP and its associated channel from the list of access points detected by the peripheral device and provided to the STA (e.g., in the results message).

The STA may then perform a directed scanning operation for the target AP (1060). The directed scanning operation may be targeted specifically to the target AP, and may be used to determine which capabilities of the STA are actually supported by the target AP. For example, the STA may broadcast a probe request on channel CH_K, only, at time t₄. The probe request may indicate a number of communication capabilities specifically supported by the STA. The target AP may respond to the probe request by sending a probe response back to the STA, at time t₅, mirroring the information provided in the probe request intersected with the capabilities supported by the target AP.

Finally, the STA may initiate a wireless connection exchange with the target AP to set up a wireless connection between the devices (1070). For example, the STA may perform an authentication operation (e.g., from times t₆ to t₇), followed by an association operation (e.g., from times t₇ to t₈), with the target AP. Finally, the STA may perform a 4-way handshake operation with the target AP to negotiate a set of cryptographic keys that may be used to enable secure data communications between the devices. In some embodiments, the STA may offload some or all of the wireless connection exchange to the peripheral device (e.g., as described above with respect to FIGS. 8 and 9).

FIG. 11 shows a flowchart depicting an example operation 1100 for offloading a wireless channel scanning operation by an AP to a peripheral device. With reference, for example, to FIG. 7, the operation 11000 may be performed by the AP 700 to offload a background channel scanning operation to a peripheral device tethered to the AP 700 (not shown for simplicity). In example embodiments, the AP 700 may communicate with the peripheral device via a secondary (e.g., Bluetooth) communications link.

The AP 700 instructs the peripheral device to perform a channel scanning operation (1110). For example, the processor 730 may execute the CS offload SW module 743 to generate a CS offload message. The CS offload message may include instructions, and any necessary information, for identifying and/or scanning all available channels for the given wireless communications protocol. For some embodiments, after handing off the channel scanning operation to the peripheral device, the AP 700 may continue serving client STAs on its current wireless channel (1115).

The peripheral device then performs a scan of the available wireless channels on behalf of the AP 700 (1120), and gathers channel information for each scanned channel (1130). For example, the peripheral device may tune to each of the available channels to listen for wireless signals and/or other activity on the channel. The peripheral device may collect channel information such as, for example, channel occupancy (e.g., the number of BSSs), signal strength (e.g., RSSI information), and/or traffic distribution (e.g., the amount of data traffic or wireless activity) on each wireless channel.

Upon completing the channel scanning operation, the peripheral device provides a set of channel scan results to the AP 700 (1140). For example, the channel scan results may include the channel information for each channel scanned by the peripheral device. For some embodiments, the AP 700 may store the received channel information in the channel information data store 742, to be used at a later time (e.g., when the processor 730 executes the channel switching SW module 744).

The AP 700 may determine the “best” quality wireless channel from the received scan results (1150). For example, the processor 730 may execute the channel switching SW module 744 to compare the channel information for each of the wireless channels and identify the best quality wireless channel. The best quality wireless channel may be the channel with the lowest noise and/or interference (e.g., caused by other wireless devices operating on the same and/or neighboring channels).

The AP 700 may then selectively migrate its WLAN over to the best quality channel (1160). For example, the processor 730, in executing the channel switching SW module 744, may migrate the WLAN over to the best quality wireless channel by tuning the transceiver 711 to the frequency of the new wireless channel and instructing each client STA to do the same (e.g., by broadcasting channel switching messages to the client STAs). In some instances, the best quality wireless channel may be the wireless channel that the AP 700 is currently on. Thus, the channel switching SW module 744, as executed by the processor 730, may perform a channel switching operation only if it detects a better-quality wireless channel than the current wireless channel.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for connecting a wireless station (STA) to an access point (AP), the method being performed by the STA and comprising:
initiating a wireless connection exchange with the AP;
offloading at least a portion of the wireless connection exchange to a peripheral device;
receiving a message from the peripheral device in response to the offloading; and
enabling secure data communications with the AP based at least in part on the message received from the peripheral device.

2. The method of claim 1, wherein the offloading comprises:
sending a handoff message to the peripheral device, the handoff message containing at least one member of the group consisting of instructions to perform the wireless connection exchange on behalf of the STA, identification information of the AP, and a wireless channel upon which the AP is to operate.

3. The method of claim 1, wherein the portion of the wireless connection exchange includes an Extensible Authentication over Local Area Network (EAPoL) handshake operation.

4. The method of claim 3, further comprising:
receiving a set of encryption keys, from the peripheral device, in the message.

5. The method of claim 4, wherein the enabling of secure data communications comprises:
encrypting or decrypting data communications with the AP using the set of encryption keys.

6. The method of claim 1, wherein the STA is wirelessly connected to the peripheral device via a Bluetooth link or a near field communication (NFC) link, and the STA is wirelessly connected to the AP via a Wi-Fi link.

7. The method of claim 1, further comprising:
instructing the peripheral device to scan a plurality of wireless channels to detect nearby APs on behalf of the STA.

8. The method of claim 1, wherein initiating the wireless connection exchange further comprises:
instructing the peripheral device to scan a plurality of wireless channels to detect a presence of the AP on behalf of the STA;
receiving a result of the scan from the peripheral device; and
identifying the AP based on the result of the scan.

9. The method of claim 8, wherein the result includes a wireless channel associated with the AP, the method further comprising:
performing a directed scan of the wireless channel to initiate the wireless connection exchange with the AP.

10. A wireless device, comprising:
one or more processors; and
a memory storing instructions that, when executed by the one or more processors, cause the wireless device to:
initiate a wireless connection exchange with an access point (AP);
offload at least a portion of the wireless connection exchange to a peripheral device;
receive a message from the peripheral device in response to the offload; and
enable secure data communications with the AP based at least in part on the message received from the peripheral device.

11. The wireless device of claim 10, wherein the portion of the wireless connection exchange includes an Extensible Authentication over Local Area Network (EAPoL) handshake operation.

12. The wireless device of claim 10, wherein execution of the instructions causes the wireless device to further:
receive, from the peripheral device, a set of encryption keys; and
encrypt or decrypt data communications with the AP using the set of encryption keys.

13. The wireless device of claim 10, wherein the wireless device is wirelessly connected to the peripheral device via a Bluetooth link or a near field communication (NFC) link, and the wireless device is wirelessly connected to the AP via a Wi-Fi link.

14. The wireless device of claim 10, wherein execution of the instructions further causes the wireless device to:
instruct the peripheral device to scan a plurality of wireless channels to detect nearby APs on behalf of the wireless device.

15. The wireless device of claim 10, wherein execution of the instructions further causes the wireless device to:
instruct the peripheral device to scan a plurality of wireless channels to detect a presence of the AP on behalf of the STA; and
receive a result of the scan from the peripheral device;
identify the AP based on the result of the scan.

16. The wireless device of claim 15, wherein the result includes a wireless channel associated with the AP, and wherein execution of the instructions further causes the wireless device to:
perform a directed scan of the wireless channel to initiate the wireless connection exchange with the AP.

17. A non-transitory computer-readable medium storing instructions that, when executed by one or more processors of a wireless device, cause the wireless device to connect to an access point (AP) by performing operations comprising:
initiating a wireless connection exchange with the AP;
offloading at least a portion of the wireless connection exchange to a peripheral device;
receiving a message from the peripheral device in response to the offloading; and
enabling secure data communications with the AP based at least in part on the message received from the peripheral device.

18. The non-transitory computer-readable storage medium of claim 17, wherein the portion of the wireless connection exchange includes an Extensible Authentication over Local Area Network (EAPoL) handshake operation.

19. The non-transitory computer-readable storage medium of claim 18, wherein execution of the instructions causes the wireless device to perform operations further comprising:
receiving, from the peripheral device, a set of encryption keys; and
encrypting or decrypting data communications with the AP using the set of encryption keys.

20. The non-transitory computer-readable storage medium of claim 17, wherein execution of the instructions further causes the wireless device to perform operations further comprising:
instructing the peripheral device to scan a plurality of wireless channels to detect nearby APs on behalf of the wireless device;
receiving a result of the scan from the peripheral device;
identifying the AP based on the result of the scan, wherein the result includes a wireless channel associated with the AP; and
performing a directed scan of the wireless channel to initiate the wireless connection exchange with the AP.
